(19) United States
(12) Patent Application Publication
(10) Pub. No.: US 2026/0211445 A1
(43) Pub. Date: Jul. 23, 2026

(54) MOUNT BRACKET FOR A KNOB ASSEMBLY OF A COOKING APPLIANCE

(71) Applicant: Haier US Appliance Solutions, Inc., Wilmington, DE (US)

(72) Inventors: Shawn Coulter, Ringgold, GA (US); Zachery Reed, Ringgold, GA (US)

(21) Appl. No.: 19/026,934

(22) Filed: Jan. 17, 2025

(51) Int. Cl. G05G 1/10; F24C 3/12; F24C 7/08; G05G 1/015

(52) U.S. Cl. CPC G05G 1/10; F24C 3/126; F24C 7/082; G05G 1/015

(57) ABSTRACT

A knob assembly may include a position sensor disposed on a rear face of a surface panel of a cooking appliance. The position sensor may include a sensor collar. The knob assembly may include a mount bracket that may secure the position sensor to the surface panel. The mount bracket may define a sensor aperture in receipt of the sensor collar. The mount bracket may include one or more bracket orientation tabs. The one or more bracket orientation tabs may extend from the mount bracket in selective engagement with the position sensor.

### FIELD OF THE DISCLOSURE

The present subject matter relates generally to a cooking appliance, and more particularly to a mount bracket for a cooking appliance.

### BACKGROUND OF THE DISCLOSURE

Knobs are commonly used on a variety of commercial and residential appliances to control an operating condition of the appliance. Knobs are particularly common on cooking appliances, such as stoves or cooktops. Various shapes and sizes can be used depending upon, for example, the intended application, aesthetics, and other factors.

For example, cooking appliances that include a cooktop traditionally have at least one heating element positioned on a panel proximate a cooktop surface for use in heating or cooking an object, such as a cooking utensil, and its contents. The heating element can operate to heat a cooking utensil directly through induction heating, or may use another heat source such as electrically resistant coils or gas burners. Commonly, one knob corresponds to one or more heating elements such that rotation of the knob activates, ignites, or otherwise adjusts heat generated at the corresponding heating elements. Many knobs include a position sensor mounted within the cooking appliance, such as to an inner wall of the user interface assembly. The position sensor is configured for determining a rotational position of the knob. Challenges exist with mounting position sensors to cooking appliances. For example, many manufacturers utilize readily available or generic position sensors that are not specifically designed for the cooking appliance. In such instances, the position sensors often do not include the correct mounting features or any mounting features at all.

Accordingly, a cooking appliance that obviates one or more of the above mentioned challenges would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a knob assembly for a cooking appliance is provided. The cooking appliance may include a user interface assembly. The user interface assembly may include a surface panel. The knob assembly may include a position sensor disposed on a rear face of the surface panel. The position sensor may include a sensor collar. The knob assembly may include a mount bracket that may secure the position sensor to the surface panel. The mount bracket may define a sensor aperture in receipt of the sensor collar. The mount bracket may include one or more bracket orientation tabs. The one or more bracket orientation tabs may extend from the mount bracket in selective engagement with the position sensor.

In another exemplary aspect of the present disclosure, a cooking appliance is provided. The cooking appliance may include a user interface assembly. The user interface assembly may include a surface panel. The surface panel may include a front face and a rear face. The cooking appliance may include a knob assembly. The knob assembly may include a position sensor disposed on a rear face of the surface panel. The position sensor may include a sensor collar. The knob assembly may include a mount bracket that may secure the position sensor to the surface panel. The mount bracket may define a sensor aperture in receipt of the sensor collar. The mount bracket may include one or more bracket orientation tabs. The one or more bracket orientation tabs may extend from the mount in selective engagement with the position sensor.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to one or more exemplary embodiments of the present subject matter.

FIG. 2 provides an exploded view of a user interface of the cooking appliance of FIG. 1.

FIG. 3 provides a rear perspective view of a user interface of the cooking appliance of FIG. 1.

FIG. 4 provides a perspective view of a mount bracket mated to a position sensor according to or more exemplary embodiments of the present subject matter.

FIG. 5 provides a perspective view of a mount bracket mated to a position sensor according to or more exemplary embodiments of the present subject matter.

FIG. 6 s a perspective view of a mount bracket mated to a position sensor according to or more exemplary embodiments of the present subject matter.

FIG. 7 provides a perspective view of a mount bracket mated to a position sensor according to or more exemplary embodiments of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Embodiments of the present disclosure provide a mount bracket for installing a position sensor, such as a potentiometer onto a user interface assembly of a cooking appliance. Notably, the mount bracket is designed to screw onto the sensor collar of the position sensor. Bracket orientation tabs formed on the mount bracket are configured to engage with corresponding casing orientation tabs formed on the position sensor to align and orient the mount bracket to the position sensor. In particular, the mount bracket screws onto the sensor collar until the bracket orientation tabs contact or engage with the casing orientation tabs. Thus, the mount bracket may be advantageously stopped in the correct orientation for installation onto the user interface assembly. In additional or alternative embodiments, the mount bracket can be screwed directly onto a shaft of the position sensor. In some such embodiments, the bracket orientation tabs are still used to align and orient the mount bracket to the position sensor. The mount bracket would then attach to the user interface assembly via one or more mechanical fasteners. In turn, aspects of the present disclosure may advantageously reduce part count of the cooking appliance, which may reduce production costs, labor times during the manufacturing process, complexity of assembly during the manufacturing process, inventory management during the manufacturing process, or the opportunity of defects or repairs during the manufacturing process (e.g., when compared to traditional methods of attaching a position sensor to the user interface assembly of a cooking appliance).

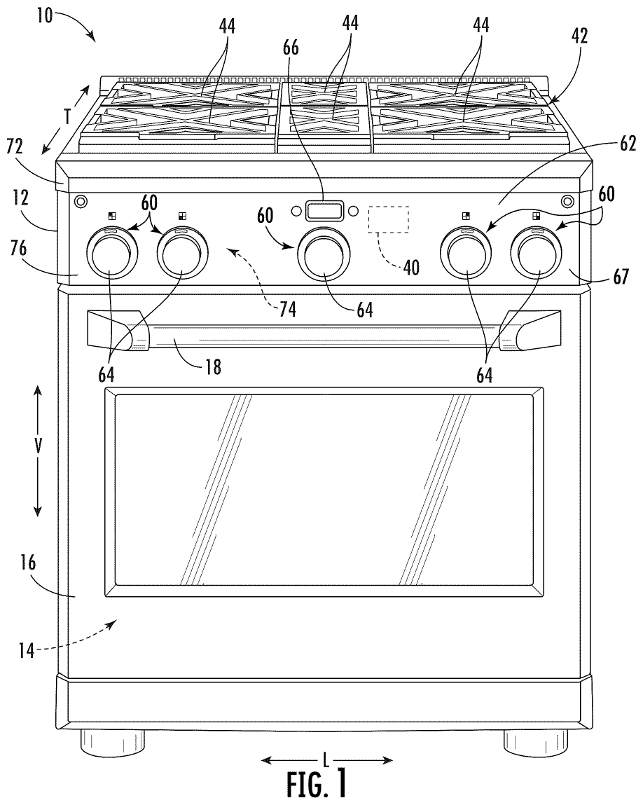

Turning now to the figures, FIG. 1 provides a perspective view of a cooking appliance, such as an oven appliance 10, according to exemplary embodiments of the present disclosure. Generally, oven appliance 10 defines a vertical direction V, a lateral direction L, and a transverse direction T. The vertical direction V, lateral direction L, and transverse direction T are mutually perpendicular and form an orthogonal direction system. As will be understood, oven appliance 10 is provided by way of example only, and the present subject matter may be used in any suitable appliance. Thus, the present disclosure may be used with other oven, range, or cooktop appliance configurations (e.g., configurations that define multiple interior cavities for the receipt of food, include no interior cavities, or are otherwise different than the configuration shown in FIG. 1), as well as other suitable appliances, as would be understood in light of the present disclosure.

Oven appliance 10 includes an insulated cabinet 12 with an interior cooking chamber 14 defined by an interior surface of cabinet 12. Cooking chamber 14 is configured for the receipt of one or more food items to be cooked. Oven appliance 10 includes a door 16 rotatably mounted to cabinet 12. A handle 18 may be mounted to door 16 and may assist a user with opening and closing door 16 in order to access an opening to cooking chamber 14. For example, a user can pull on handle 18 to open or close door 16 and access cooking chamber 14 through the opening. As would be understood, one or more internal heating elements (e.g., baking or broiling heating elements) may be provided within cooking chamber 14 to cook or otherwise heat items therein.

Oven appliance 10 may include a seal between door 16 and cabinet 12 that assist with maintaining heat and cooking fumes within cooking chamber 14 when door 16 is closed, as shown in FIG. 1. One or more parallel glass panes 22 provide for viewing the contents of cooking chamber 14 when door 16 is closed and assist with insulating cooking chamber 14. Optionally, a baking rack may be positioned in cooking chamber 14 for the receipt of food items or utensils containing food items.

In some embodiments, oven appliance 10 includes a cooktop surface 42 having one or more heating elements 44 for use in heating or cooking operations. In exemplary embodiments, cooktop surface 42 is comprised of metal (e.g., steel) panel on which one or more grates may be supported. In other embodiments, however, cooktop surface 42 may be comprised of another suitable material, such as a ceramic glass or another suitable non-metallic material. Heating elements 44 may be various sizes, as shown in FIG. 1, and may employ any suitable method for heating or cooking an object, such as a cooking utensil, and its contents. In one embodiment, for example, heating element uses a heat transfer method, such as electric coils or gas burners, to heat the cooking utensil. In another embodiment, however, heating element 44 uses an induction heating method to heat the cooking utensil directly. In turn, heating element may include a burner element, electric heat element, induction element, or another suitable heating element.

Some embodiments of oven appliance 10 include a controller 40 (e.g., configured to control one or more operations of oven appliance 10). For example, controller 40 may control at least one operation of oven appliance 10 that includes an internal heating element or cooktop heating element 44. Controller 40 may be in communication (via for example a suitable wired or wireless connection) with one or more of heating element(s) 44 and other suitable components of oven appliance 10, as discussed herein. In general, controller 40 may be operable to configure oven appliance 10 (and various components thereof) for cooking. Such configuration may be based, for instance, on a plurality of cooking factors of a selected operating cycle or mode.

By way of example, controller 40 may include one or more memory devices and one or more microprocessors, such as general or special purpose microprocessors operable to execute programming instructions or micro-control code associated with an operating cycle. The memory may represent random access memory such as DRAM, or read only memory such as ROM or FLASH. In one embodiment, the processor executes programming instructions stored in memory. The memory may be a separate component from the processor or may be included onboard within the processor.

Controller 40 may be positioned in a variety of locations throughout oven appliance 10. As illustrated, controller 40 may be located within a user interface assembly 62 of oven appliance 10. In some such embodiments, input/output (“I/O”) signals may be routed between controller 40 and various operational components of oven appliance 10, such as heating element(s) 44, control knobs 64, display component 66, sensors, alarms, or other components as may be provided. For instance, signals may be directed along one or more wiring harnesses that may be routed through cabinet 12. In some embodiments, controller 40 is in communication with user interface assembly 62 and control knobs 64 through which a user may select various operational features and modes and monitor progress of oven appliance 10. In one embodiment, user interface assembly 62 may represent a general purpose I/O (“GPIO”) device or functional block. In one embodiment, user interface assembly 62 may include input components, such as one or more of a variety of electrical, mechanical, or electro-mechanical input devices including rotary dials, push buttons, and touch pads. User interface assembly 62 may include a display component 66, such as a digital or analog display configured to provide operational feedback to a user.

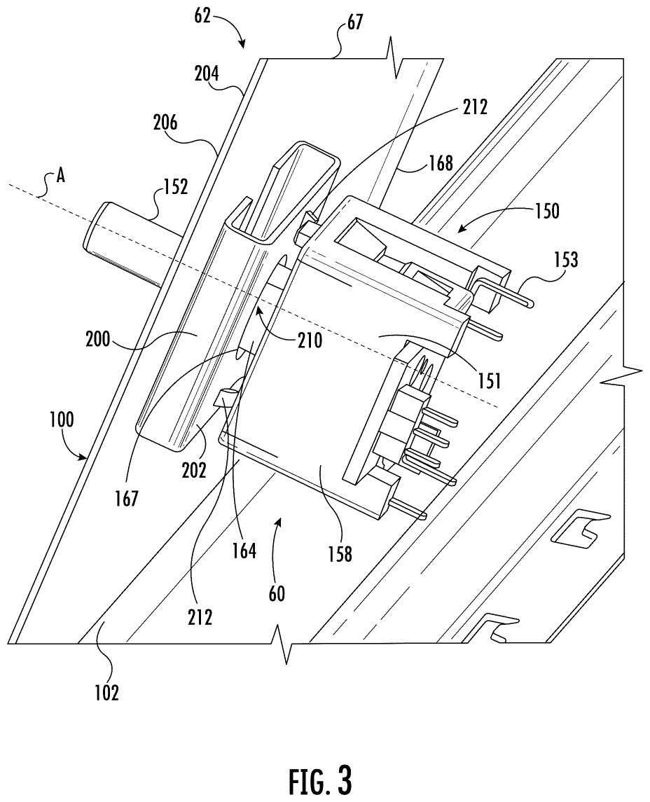

Referring now to FIGS. 1 and 3, embodiments of the user interface assembly 62 and components thereof are provided. During use of oven appliance 10, the amount of heat delivered by each heating element 44 on cooktop 42 may be controlled by controller 40 and a corresponding knob assembly 60. For instance, each knob assembly 60 may be mounted or fastened to a surface panel 67 of the user interface assembly 62.

Each knob assembly 60 may correspond to a discrete heating element 44 of the cooking appliance 10. The surface panel 67 may include a front face 100 and a rear face 102. In some embodiments, surface panel 67 defines one or more axes or opening to permit mechanical or electrical connections between portions of knob assembly 60 or controller 40 (e.g., within cabinet 12). For instance, surface panel may define a central axis A (e.g., FIG. 3) through a shaft aperture 104 extending from the rear face 102 to the front face 100. Thus, in exemplary embodiments, the front face 100 of the surface panel 67 may be a front or forward facing surface of the user interface assembly 62 that a consumer may interact with. For instance, a consumer may interact with the knob assemblies 60 disposed at the surface panel 67. However, in additional or alternative embodiments, the surface panel 67 may be a top or upward facing surface of the user interface assembly 62. In such instances, the user inputs, such as the control knobs (e.g., control knobs 64), touch buttons, etc., of the user interface assembly 62 may face upward, for instance along the vertical direction V.

The user interface assembly 62 may define one or more shaft apertures 104 through the surface panel 67 through which a shaft 152 of a position sensor 150 is received. Each shaft aperture 104 may correspond to a discrete knob assembly 60. For instance, each shaft aperture 104 may receive a portion of the discrete knob assembly 60 therethrough. In addition, the user interface assembly 62 may define one or more panel fastener holes 106 through the surface panel 67. The panel fastener holes may receive mechanical fasteners 108, such as screws, bolts, or the like therethrough to secure or fasten the corresponding discrete knob assembly 60 to the surface panel 67. As will be appreciated in more detail below, the mechanical fasteners 108 may secure or fasten a position sensor 150 of the knob assembly 60 indirectly to the surface panel 67 via a mount bracket 200. In the exemplary embodiments, the panel fastener holes 106 are positioned radially outward (e.g., positioned to the left and right) of the shaft apertures 104. However, in additional or alternative embodiments, the panel fastener holes 106 may be offset from or otherwise positioned in any suitable manner relative to the corresponding shaft aperture 104. For example, in additional or alternative embodiments, the panel fastener holes 106 may be positioned above or below the corresponding shaft aperture 104.

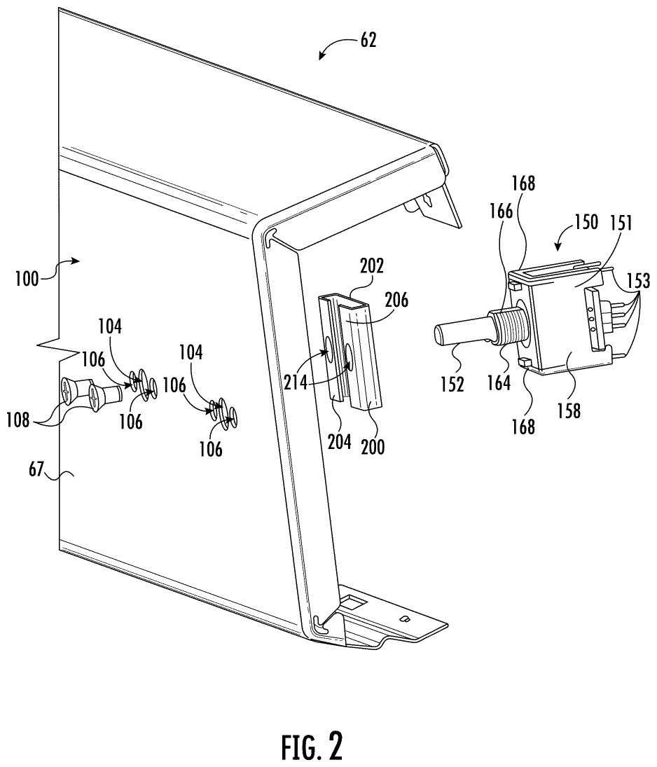

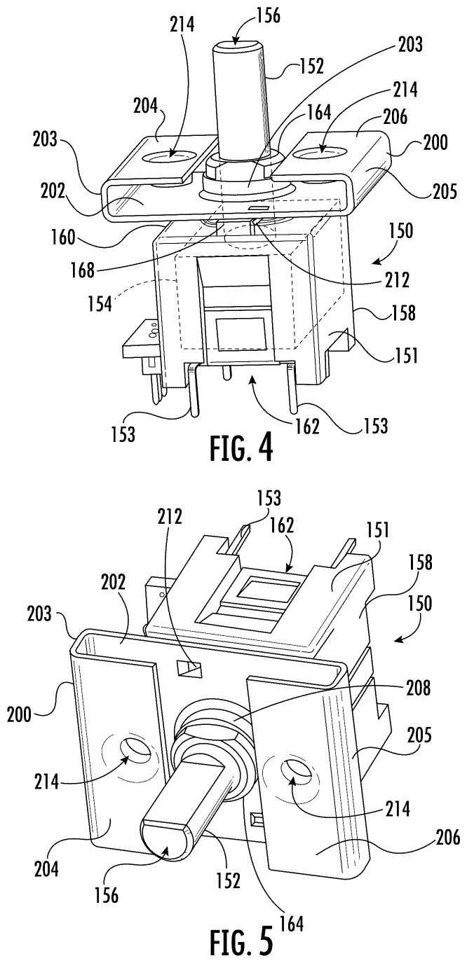

Referring now to FIGS. 2 through 5, embodiments of the user interface assembly 62 and the knob assembly 60 are provided. The knob assembly 60 may include a position sensor 150 for determining the position of the control knob 64 attached thereto. In particular, the position sensor 150 may be capable of determining the position of the control knob 64 by converting the position of the control knob 64 to a signal and transmitting the signal to the controller 40. In the exemplary embodiment, the position sensor 150 is provided as a potentiometer 151. As will be understood by those skilled in the art, the potentiometer 151 may generally include a shaft 152 that is rotatably mounted to a resistive component 154 (e.g., FIG. 4). The position sensor 150 may be in operable communication with the controller 40 of the cooking appliance 10. For example, the position sensor 150 may include one or more electrical terminals 153 that electrically or operably couple the resistive component 154 of the position sensor 150 to the controller 40.

In general, the resistive component 154 may detect angular movement of the shaft 152 relative to the resistive component 154. The detected angular movement of the shaft 152 may correspond to an adjustment (e.g., an increase or decrease) of a resistance the resistive component 154. The resistance of the resistive component 154 may correspond to an output voltage of the resistive component 154. The output voltage received from the resistive component 154 may determine an operational setting of the cooking appliance 10. In this regard, when a user manipulates the position of the control knob 64, the position sensor 150 may output a voltage corresponding to the movement of the control knob 64. For example, the voltage output by the resistive component 154 when the position of the control knob 64 is manipulated may correspond to a power level of a corresponding heating element 44.

In additional or alternative exemplary embodiments, the position sensor 150 is provided as or includes any suitable sensor or device capable of detecting a position of the control knob 64. For example, in additional or alternative exemplary embodiments, the position sensor 150 is provided as or includes a digital encoder or a rheostat.

A distal end 156 of the shaft 152 may be extended through the shaft aperture 104 such that the control knob 64 may be mounted to shaft 152 at the distal end 156 of the shaft 152 to mount the shaft 152 at the front face 100 of the surface panel 67. As mentioned above, in exemplary embodiments, the shaft 152 is rotatably mounted to the resistive component 154 of the knob assembly 60. The resistive component 154, and at least a portion of the shaft 152, such as a proximal end of the shaft 152, may be encased or housed within a casing 158 of the position sensor 150. The casing 158 may include one or more casing orientation tabs 168 extended from a front face 160 thereof, for instance, toward the surface panel 67. As will be appreciated in more detail below, the one or more casing orientation tabs 168 may engage with the position sensor 150 and advantageously orient and align a mount bracket 200 to the position sensor 150.

The shaft 152 may include a first thread 166 (e.g., FIG. 2) disposed at an outer surface thereof. In the exemplary embodiments, the shaft 152 includes a sensor collar 164 disposed at the front face 160 of the casing 158. In some such embodiments, the first thread 166 is disposed at an outer surface of the sensor collar 164. In particular, the sensor collar 164 may be positioned around the shaft 152 at the front face 160. As will be appreciated in more detail below, the sensor collar 164 may be mated (e.g., threadedly engaged) to a mount bracket 200 of the knob assembly 60.

The knob assembly 60 may also include the mount bracket 200 securing the position sensor 150 to the surface panel 67. The mount bracket 200 may mount or attach the position sensor 150 to the surface panel 67. For instance, the position sensor 150 may be disposed on the rear face 102 of the surface panel 67 via the mount bracket 200. The mount bracket 200 advantageously allows generic or readily available panel mount positions sensors, such as position sensor 150, to be secured (e.g., retrofit) to the user interface assembly 62. The mount bracket 200 may advantageously orient itself to the position sensor 150 for proper installation of the position sensor 150.

In some exemplary embodiments, the mount bracket 200 is a formed component or a component constructed via a forming process, such as a bending, stamping, die forming, or the like. For instance, the mount bracket 200 may be formed from a single piece of material, such as a single piece of sheet metal. As shown in FIGS. 2 through 5, the mount bracket 200 may be formed to include a mount plate 202, a first fastener plate 204, and a second fastener plate 206. In some such exemplary embodiments, the position sensor 150 is mounted or attached to the mount bracket 200 at the mount plate 202. For instance, the mount plate 202 may define a sensor aperture 210 in receipt of the position sensor 150, and more particular, of the sensor collar 164. In some exemplary embodiments, the mount bracket 200 may also include a bracket collar 208 that defines, at least in part, the sensor aperture 210. For instance, the bracket collar 208 may be a hollow cylindrical portion of the mount bracket 200 that extends along the central axis A. The bracket collar 208 may define a sensor aperture 210 for the receipt of the position sensor 150. The bracket collar 208 may include a second thread 167 at an inner surface of the bracket collar 208. The second thread 167 may threadedly engage with the first thread 166. In this regard, the mount bracket 200 may be mounted or mated to the position sensor 150.

The mount bracket 200 may include one or more bracket orientation tabs 212 in selective engagement with the position sensor 150. In some exemplary embodiments, the one or more bracket orientations tabs 212 may extend from the mount plate 202, for instance, toward the front face 160 of the casing 158. The one or more bracket orientations tabs 212 may engage with the one or more casing orientation tabs 168, for instance, when the mount bracket 200 is threaded onto the position sensor 150, to orient and align the mount bracket 200 to the position sensor 150. The mount bracket 200 may screw onto the sensor collar 164 until the bracket orientations tabs 212 contact the casing orientation tabs 168. This contact may stop the mount bracket 200 in the correct installation orientation, such as the orientation shown in FIGS. 3 through 5.

The first fastener plate 204 and the second fastener plate 206 may be extended from opposing sides (e.g., opposing radial or lateral sides) of the mount plate 202. In particular, the first fastener plate 204 and the second fastener plate 206 may be spaced apart from the mount plate 202, for instance, along the transverse direction T. A first connection body 203 may extend between the mount plate 202 and the first fastener plate 204. The first connection body 203 may be configured such that the first fastener plate 204 may extend generally parallel to the mount plate 202. For example, the first connection body 203 may be a straight, arcuate, or curved body that extends between the mount plate 202 and the first fastener plate 204. A second connection body 205 may extend between the mount plate 202 and the second fastener plate 206. The second connection body 205 may be configured such that the second fastener plate 206 may extend generally parallel to the mount plate 202. For example, the second connection body 205 may be straight, arcuate, or a curved body that extends between the mount plate 202 and the second fastener plate 206.

The first fastener plate 204 and the second fastener plate 206 may each define a bracket fastener hole 214 therethrough. The bracket fastener holes 214 of the first fastener plate 204 and the second fastener plate 206 may be aligned with the panel fastener holes 106 relative to the central axis A in a predetermined installation orientation of the mount bracket 200. In this regard, the mechanical fasteners 108, such as a screw, bolt, or the like may be disposed within the bracket fastener holes 214 to fasten the mount bracket 200, and indirectly the position sensor 150, to the surface panel 67.

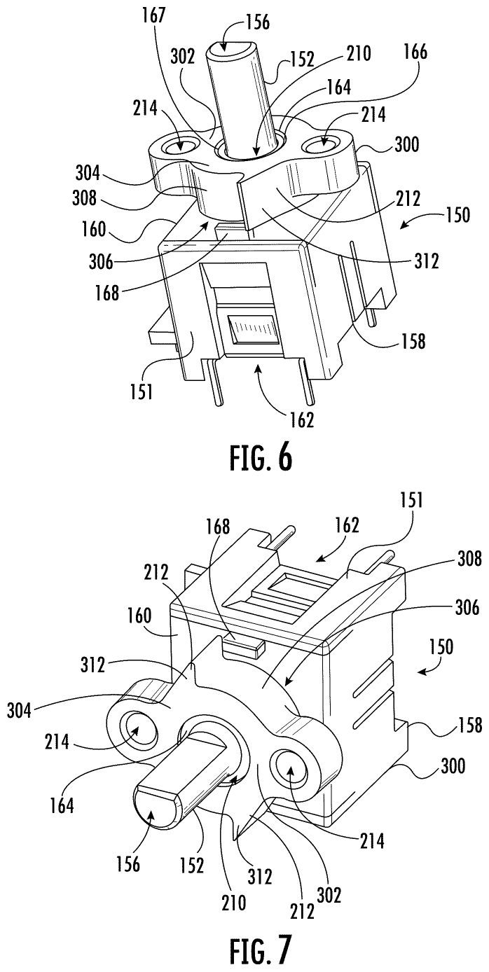

Referring now to FIGS. 6 and 7, perspective views of a mount bracket 300 mounted to a position sensor 150 in accordance with another exemplary aspect of the present disclosure is provided. The exemplary mount bracket 300 of FIGS. 6 and 7 may be configured in substantially the same manner as the exemplary mount bracket 200 of FIGS. 2 through 5, and accordingly, the same or similar numbers may refer to the same or similar parts.

For example, the exemplary mount bracket 300 of FIGS. 6 and 7 defines a sensor aperture 210 and one or more bracket fastener holes 214 therethrough. However, for the embodiment of FIGS. 6 and 7, the mount bracket 300 may now include or be provided as a molded mount body 302. The molded mount body 302 may be constructed via a molding process, such as injection molding, cast molding, or the like. The molded mount body 302 may define the sensor aperture 210 therethrough. The molded mount body 302 may also include a second thread 167 that may threadedly engage with a first thread 166 of a sensor collar 164. The molded mount body 302 may generally include a front surface 304, a rear surface 306, and an outer arcuate surface 308. The outer arcuate surface 308 may be an arched or curved surface that is positioned between the front surface 304 and the rear surface 306.

The exemplary mount bracket 300 may also include one or more bracket orientation tabs 212 in selective engagement with the position sensor 150. However, for the embodiment of FIGS. 6 and 7, the bracket orientation tabs 212 may include or be provided as fins 312 that extend outward from the outer surface 308 of the molded mount body 302. Notably, the fins 312 may contact or engage with the one more casing orientation tabs 168 (e.g., in a secured or mounted position of the mount bracket 300 on the sensor collar 164 of the position sensor 150), thereby orienting the mount bracket 300 relative to the position sensor 150.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A knob assembly for a cooking appliance, the cooking appliance comprising a user interface assembly, the user interface assembly comprising a surface panel, the knob assembly comprising:
a position sensor disposed on a rear face of the surface panel, the position sensor comprising a sensor collar; and
a mount bracket securing the position sensor to the surface panel, the mount bracket defining a sensor aperture in receipt of the sensor collar, the mount bracket comprising one or more bracket orientation tabs, the one or more bracket orientation tabs extending from the mount bracket in selective engagement with the position sensor.

2. The knob assembly of claim 1, wherein the position sensor further comprises a shaft, a casing, and a resistive component,
wherein the shaft is rotatably mounted to the resistive component,
wherein the casing encases the resistive component and a portion of the shaft,
wherein the casing is extended between a front face and a rear face, and
wherein the sensor collar is disposed around the shaft at the front face of the casing.

3. The knob assembly of claim 2, wherein the casing comprises one or more casing orientation tabs,
wherein the one or more casing orientation tabs extend from the front face of the casing toward the surface panel, and
wherein the one or more bracket orientation tabs are engaged with the one or more casing orientation tabs to orient the mount bracket relative to the position sensor.

4. The knob assembly of claim 2, wherein the position sensor further comprises one or more electrical terminals, and
wherein the one or more electrical terminals are in operable communication between the resistive component and a controller of the cooking appliance.

5. The knob assembly of claim 2, wherein the surface panel defines a shaft aperture through which the shaft is received.

6. The knob assembly of claim 2, further comprising:
a control knob mounted to the shaft of the position sensor, the control knob being disposed at the front face of the surface panel.

7. The knob assembly of claim 1, wherein the mount bracket comprises a mount plate, and
wherein the one or more bracket orientation tabs are extended from the mount plate toward the position sensor.

8. The knob assembly of claim 1, wherein the mount bracket comprises a molded mount body,
wherein the molded mount body comprises a front surface, a rear surface, and an outer arcuate surface,
wherein the outer arcuate surface is positioned between the front surface and the outer surface, and
wherein the one or more bracket orientation tabs extend from the outer arcuate surface of the molded mount body.

9. The knob assembly claim 1, wherein the sensor collar comprises a first thread at an outer surface thereof,
wherein the mount bracket comprises a second thread at an inner surface thereof, and
wherein the first thread and the second thread are threadedly engaged.

10. The knob assembly of claim 1, wherein the surface panel comprises one or more panel fastener holes therethrough,
wherein the mount bracket further defines one or more bracket fastener holes therethrough, and
wherein the one or more panel fastener holes are aligned with the one or more bracket fastener holes relative to a central axis defined through the surface panel.

11. A cooking appliance comprising:
a user interface assembly comprising a surface panel, the surface panel comprising a front face and a rear face; and
a knob assembly comprising:
a position sensor disposed on a rear face of the surface panel, the position sensor comprising a sensor collar; and
a mount bracket securing the position sensor to the surface panel, the mount bracket defining a sensor aperture in receipt of the sensor collar, the mount bracket comprising one or more bracket orientation tabs, the one or more bracket orientation tabs extending from the mount in selective engagement with the position sensor.

12. The cooking appliance of claim 11, wherein the position sensor further comprises a shaft, a casing, and a resistive component,
wherein the shaft is rotatably mounted to the resistive component,
wherein the casing encases the resistive component and a portion of the shaft,
wherein the casing is extended between a front face and a rear face, and
wherein the sensor collar is disposed around the shaft at the front face of the casing.

13. The cooking appliance of claim 12, wherein the casing comprises one or more casing orientation tabs,
wherein the one or more casing orientation tabs extend from the front face of the casing toward the surface panel, and
wherein the one or more bracket orientation tabs are engaged with the one or more casing orientation tabs to orient the mount bracket relative to the position sensor.

14. The cooking appliance of claim 12, wherein the position sensor further comprises one or more electrical terminals, and
wherein the one or more electrical terminals are in operable communication between the resistive component and a controller of the cooking appliance.

15. The cooking appliance of claim 12, wherein the surface panel defines a shaft aperture through which the shaft is received.

16. The cooking appliance of claim 12, wherein the knob assembly further comprises a control knob mounted to the shaft of the position sensor, the control knob being disposed at the front face of the surface panel.

17. The cooking appliance of claim 11, wherein the mount bracket comprises a mount plate defining the sensor aperture, and
wherein the one or more bracket orientation tabs are extended from the mount plate toward the position sensor.

18. The cooking appliance of claim 11, wherein the mount bracket comprises a molded mount body,
wherein the molded mount body comprises a front surface, a rear surface, and an outer arcuate surface,
wherein the outer arcuate surface is positioned between the front surface and the outer surface, and
wherein the one or more bracket orientation tabs extend from the outer arcuate surface of the molded mount body.

19. The cooking appliance of claim 11, wherein the surface panel comprises one or more panel fastener holes therethrough,
wherein the mount bracket further defines one or more bracket fastener holes therethrough, and
wherein the one or more panel fastener holes are aligned with the one or more bracket fastener holes.

20. The cooking appliance of claim 11, wherein the surface panel comprises one or more panel fastener holes therethrough,
wherein the mount bracket further defines one or more bracket fastener holes therethrough, and
wherein the one or more panel fastener holes are aligned with the one or more bracket fastener holes relative to a central axis defined through the surface panel.
